(19) United States
(12) Patent Application Publication
(10) Pub. No.: US 2006/0167901 A1
(43) Pub. Date: Jul. 27, 2006

(54) Live collections

(75) Inventors: Michael Muller, Medford, MA (US); Werner Geyer, Boston, MA (US); Daniel Gruen, Newton, MA (US); Andrew L. Schirmer, Andover, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/040,428

(22) Filed: Jan. 21, 2005

(51) Int. Cl. G06F 17/00

(52) U.S. Cl. 707/100

(57) ABSTRACT

A method, system and apparatus for managing live collections in a collaborative environment. In a preferred aspect of the present invention, a live collection can include a multiplicity of live objects aggregated together from which a live collection status can be obtained by reference to an application of at least one rule to a status for at least one of the aggregated live objects. The live collection can be a live activity having at least one of several live processes and live workflows. The live collection also can be a live group having multiple live names. The live collection yet further can be a live parent having multiple live objects disposed in a parent-child hierarchy. Finally, the live collection can be a live folder having multiple live documents. Notably, the rules can be logic rules, logical quantifiers, organizational quantifiers, relative quantifiers, or procedural indicators, to name a few examples. Moreover, the rules can be applied to multiple attributes of the live objects concurrently to produce a status for the live collection.

### BACKGROUND OF THE INVENTION

1. Statement of the Technical Field

The present invention relates to the field of collaborative computing and more particularly to the status awareness of objects in a collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

To facilitate collaborative aspects of a process, collaborative environments often incorporate the concept of a “live name”. A live name is a reference within the collaborative environment to a collaborator which indicates the presence of the collaborator associated with name. For example, the live name can indicate whether the collaborator has “logged in” or whether the collaborator has not utilized the collaborator's computer for some time—an idle state. Live names have been most widely utilized in the collaborative chat tool where it can be helpful to know whether a collaborator is available for an online discussion.

As an extension of the live name concept, the “live object” can provide similar, collaborative advantages. A live object refers to a reference within the collaborative environment to a document which indicates the current status of the document, for example whether or not the document is in use. The live object also can indicate the identity of a collaborator using the document. In this way, collaborators need not work in isolation towards a common goal. Rather, a team environment can be promoted by the awareness of the presence and activities of fellow collaborators in a collaborative environment.

Notwithstanding the effective notion of a live name or live object, online collaborations seldom are limited to one or two discrete objects or collaborators. Moreover, a simple awareness of the presence of a collaborator or the status of document cannot suffice for complex conditions which ought to trigger a notification for the benefit of a managing collaborator and potentially a responsive action. Presently, to achieve a more complex collaboration, an awareness of a unique circumstance can arise only manually through the multiple observations of different states of different objects and collaborators. Consequently, in many circumstances, important conditions can go unrecognized.

### SUMMARY OF THE INVENTION

The present invention addresses the deficiencies of the art in respect to live objects and live names and provides a novel and non-obvious method, system and apparatus for managing live collections in a collaborative environment. A live collection can include a multiplicity of live objects aggregated together from which a live collection status can be obtained by reference to an application of at least one rule to a status for at least one of the aggregated live objects. In one aspect of the invention, the live collection can be a live activity having at least one of several live processes and live workflows.

In another aspect of the invention, the live collection also can be a live group having multiple live names. The live collection yet further can be a live parent having multiple live objects disposed in a parent-child hierarchy. Finally, the live collection can be a live folder having multiple live documents. Notably, the rules can be logic rules, logical quantifiers, organizational quantifiers, relative quantifiers, or procedural indicators, to name a few examples. Moreover, the rules can be applied to multiple attributes of the live objects concurrently to produce a status for the live collection.

A method for managing live collections can include aggregating status information for a selection of live objects designated as belonging to a live collection. Subsequently, at least one rule can be applied to the status information to determine whether a condition has arisen for the live collection. In consequence, an action can be triggered based upon the determination of whether a condition has arisen for the live collection. The aggregating step can include writing meta-data for each of the live objects into a data store of meta-data for the live collection. The applying step can include concurrently applying at least one rule to the status information based upon at least two different attributes for each of the live objects in the live collection.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative system configured for processing live collections in accordance with the present invention;

FIG. 2A is a flow chart illustrating a process for aggregating live collection meta-data for use in the system of FIG. 1; and,

FIG. 2B is a flow chart illustrating a process for applying live collection rules to the live collection meta-data aggregated in FIG. 2B.

### DETAILED DESCRIPTION OF THE PREFERRED EMBODIMENTS

The present invention is a method, system and apparatus for managing live collections in a collaborative environment. In accordance with the present invention, a set of live objects can be aggregated into a live collection. The live objects can include, for example, both live documents and live names. Rules can be applied based upon the state of the collection of live objects which can include the state of the individual live objects in the live collection. Based upon the application of the rules, one or more conditions can be determined responsive to which one or more actions can be triggered. The triggered actions can range from a mere notification to the execution of a computing process.

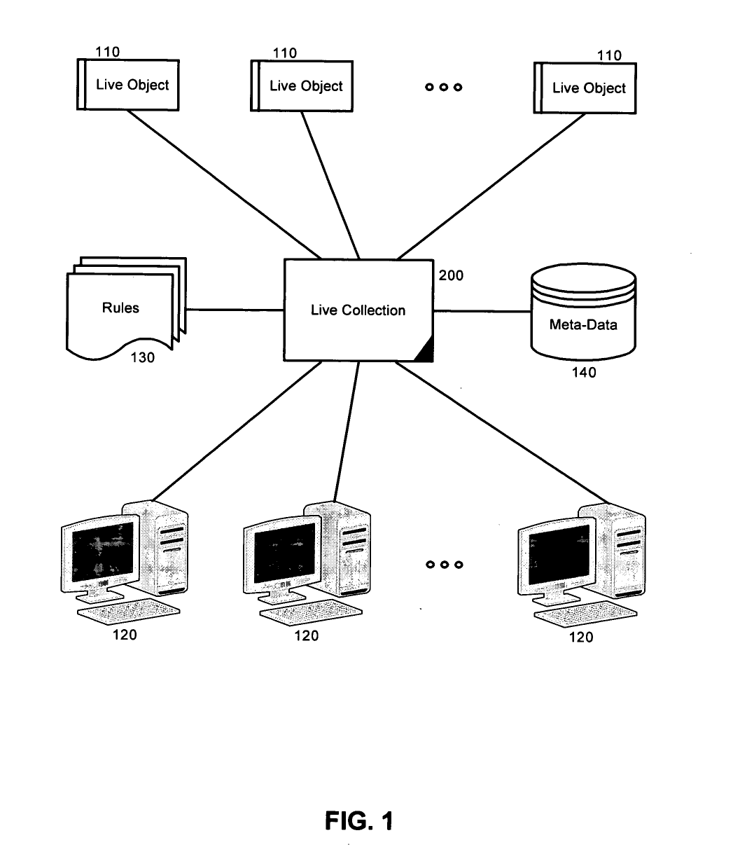

In further illustration, FIG. 1 is a schematic illustration of a collaborative system configured for processing live collections in accordance with the present invention. The system can include live collection logic 200 coupled to a multiplicity of collaborators 120 and a multiplicity of live objects 110 such as persons, documents, events, actions, processes, and activities, each having liveness. Different combinations of the live objects 110 can be combined into live collections managed by the live collection logic 200.

The live collections can include, for example, live activities such as a set of live processes or live workflows. The live collections also can include live groups such as a combination of collaborators, and live parents which can include a hierarchy of objects. Finally, the live collections can include live folders or other live containers of documents.

Notably, meta-data 140 can be collected for the live objects 110. The meta-data 140 can include the current state for each of the live objects 110 in the live collection managed by the live collection logic 200. One or more rules 130 can be applied to the meta-data 140 to detect one or more conditions or states for the live collection. Responsive to the detection of a particular condition or state, one or more actions can be undertaken which actions can range from a mere notification of one or more collaborators, to the execution of computing logic.

Importantly, the rules 130 can include simple logic or arithmetic rules including logical AND, OR, UNION and SUM. The rules 130 also can include logical quantifiers such as zero, one, at least one, some but not all, and all. The rules 130 further can include organizational quantifiers such as quorum, critical mass, and so forth. The rules 130 yet further can include relative quantifiers such as a certain percentage of the live objects 110 having a certain status or trait. Finally, the rules 130 can include comparative or procedural indicators. The procedural indicators can include a set of objects with quantified names or attributes, the highest-numbered or highest-ranked object with a particular status.

While the rules 130 can address single attributes for each of the live objects 110, the rules 130 also can address combinations of multiple attributes for the live objects 110. Examples include the requirement that several conditions co-exist across multiple attributes. Examples also can include the computation of a ratio of one condition over another condition, for instance the ratio of collaborators online to customers in a queue.

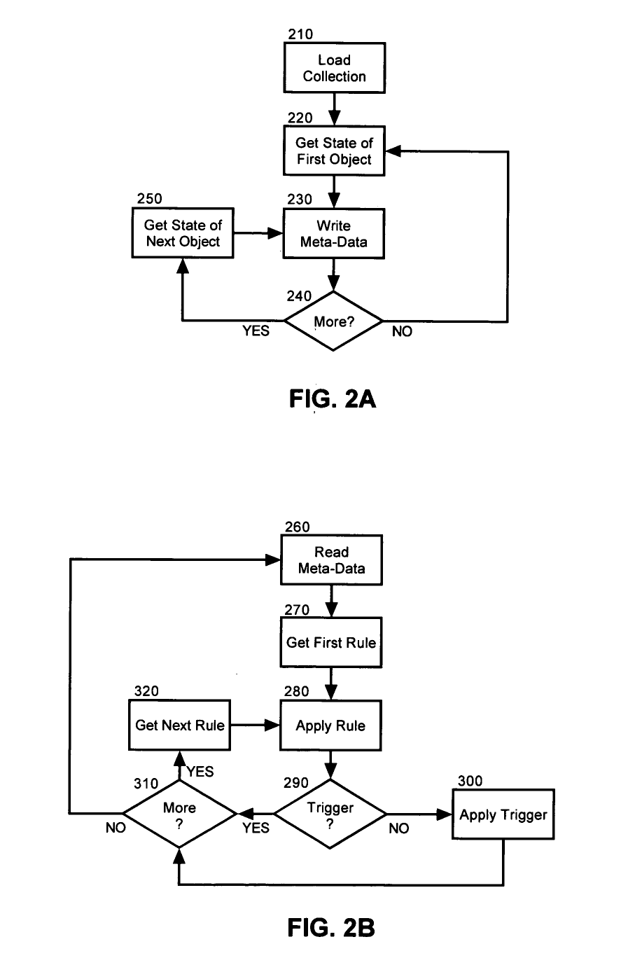

The management of the live collection can include both the synchronous aggregation of status meta-data for the live objects in the live collection and the application of the rules to the meta-data. In this regard, FIG. 2A is a flow chart illustrating a process for aggregating live collection meta-data for use in the system of FIG. 1. The aggregation process can begin in block 210 in which a live collection can be loaded for processing. In block 220, the state of the first live object in the live collection can be ascertained. In block 230, meta-data regarding the state of the live object can be written to memory. In decision block 240, if additional live objects remain in the live collection, in block 250 the state of the next live object in the live collection can be ascertained and the process can repeat through block 230. Otherwise, the process can repeat anew for the live collection through block 220.

Separate from the aggregation process, rules can be applied to the live collection to detect a specified condition and to produce a resulting action. Specifically, FIG. 2B is a flow chart illustrating a process for applying live collection rules to the live collection meta-data aggregated in FIG. 2B. Beginning in block 260, the meta-data for the live objects in the live collection can be read for processing. In block 270, a first rule can be retrieved for processing and in block 280 the rule can be applied to the meta-data.

In decision block 290, if the application of the rule is determined to result in a triggering a condition, in block 300 the trigger for the rule can be applied. Otherwise, no triggering action can occur. In either case, if in decision block 310, additional rules remain to be applied, in block 320 a next rule can be retrieved for application and the process can repeat through block 280. Otherwise, the process can continue through block 260 in which a new set of meta-data can be read for the live objects in the live collection. Subsequently, the process can begin anew through blocks 270 through 320.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A live collection comprising a plurality of live objects aggregated together from which a live collection status can be obtained by reference to an application of at least one rule to a status for at least one of said aggregated live objects.

2. The live collection of claim 1, wherein said live collection is a live activity comprising at least one of a plurality of live processes and live workflows.

3. The live collection of claim 1, wherein said live collection is a live group comprising a plurality of live names.

4. The live collection of claim 1, wherein said live collection is a live parent comprising a plurality of live objects disposed in a parent-child hierarchy.

5. The live collection of claim 1, wherein said live collection is a live folder comprising a plurality of live documents.

6. The live collection of claim 1, wherein said rules comprise logic rules.

7. The live collection of claim 1, wherein said rules comprise logical quantifiers.

8. The live collection of claim 1, wherein said rules comprise organizational quantifiers.

9. The live collection of claim 1, wherein said rules comprise relative quantifiers.

10. The live collection of claim 1, wherein said rules comprise procedural indicators.

11. The live collection of claim 1, wherein said rules are applied to multiple attributes of said live objects concurrently to produce a status for said live collection.

12. A method for managing live collections comprising the steps of:
aggregating status information for a selection of live objects designated as belonging to a live collection; and,
applying at least one rule to said status information to determine whether a condition has arisen for said live collection.

13. The method of claim 12, further comprising the step of triggering an action based upon said determination of whether a condition has arisen for said live collection.

14. The method of claim 12, wherein said set of aggregating comprises the step of writing meta-data for each of said live objects into a data store of meta-data for said live collection.

15. The method of claim 12, wherein said step of applying comprises the step of concurrently applying at least one rule to said status information based upon at least two different attributes for each of said live objects in said live collection.

16. A machine readable storage having stored thereon a computer program for managing live collections, the computer program comprising a routine set of instructions which when executed by the machine causes the machine to perform the steps of:
aggregating status information for a selection of live objects designated as belonging to a live collection; and,
applying at least one rule to said status information to determine whether a condition has arisen for said live collection.

17. The machine readable storage of claim 16, further comprising an additional set of instructions which when executed by the machine causes the machine to further perform the step of triggering an action based upon said determination of whether a condition has arisen for said live collection.

18. The machine readable storage of claim 16, wherein said set of aggregating comprises the step of writing meta-data for each of said live objects into a data store of meta-data for said live collection.

19. The machine readable storage of claim 16, wherein said step of applying comprises the step of concurrently applying at least one rule to said status information based upon at least two different attributes for each of said live objects in said live collection.
